(19) United States
(12) Patent Application Publication
(10) Pub. No.: US 2007/0295401 A1
(43) Pub. Date: Dec. 27, 2007

(54) Flow Path Block

(75) Inventors: Katsuya Okumura, Shinjuku-ku (JP); Hiroshi Itafuji, Komaki-shi (JP); Hiroki Doi, Komaki-shi (JP); Yasunori Nishimura, Komaki-shi (JP)

Correspondence Address: OLIFF & BERRIDGE, PLC, P.O. BOX 320850, ALEXANDRIA, VA, 22320-4850, US

(73) Assignees: CKD COROPORATION, KOMAKI-SHI (JP); OCTEC, INC., SHINJUKU-KU (JP)

(21) Appl. No.: 11/660,860

(22) PCT Filed: Sep. 5, 2005
(86) PCT No.: PCT/JP05/16215

§ 371 Date: Feb. 22, 2007

(30) Foreign Application Priority Data
Sep. 17, 2004 (JP) 2004-271946

(51) Int. Cl. G05D 11/00

(52) U.S. Cl. 137/115.06; 29/890.12

(57) ABSTRACT

The invention has an object to provide a flow path block capable of reducing pressure loss, providing an extremely long flow path and a complex flow path, and achieving weight reduction, and a manufacturing method thereof. A flow path block (1) comprises a block body (11) formed with through holes (21) and a groove (22) communicating with the through holes (21) and a lid member (12) which covers the groove (22). The groove (22) can be formed with any depth and width by a cutting tool to reduce pressure loss. The groove (22) can also be formed in a long shape by the cutting tool, so that a very long flow path can be provided when the groove (22) is covered with the lid member (12). The groove (22) can be made freely by the cutting tool to provide a complex flow path. Further, the thickness of the block body (11) can be reduced to achieve weight reduction.

### TECHNICAL FIELD

The present invention relates to a flow path block to be used in a fluid control system unit, and a manufacturing method thereof.

### BACKGROUND ART

As a related art, there is a flow path block 101 having a V-shaped flow path as shown in FIGS. 18 and 19. FIG. 18 is a top view and FIG. 19 is a sectional view taken along line A-A. This flow path block 101 includes a block body 111 in which a V-shaped flow path 121 is formed by a cutting tool (e.g., a drill). Further, a portion which will be connected to a unit is formed as a seal area 121a.

Patent document 1 discloses a flow path block 201 as shown in FIGS. 21 to 24.

Here, a method of manufacturing this flow path block 201 will be described below.

In a first step, as shown in FIG. 21, a block body 211 is formed with a first open path 221 which is bored from above and an auxiliary path 223 and a communicating path 222 which are bored from side so as to communicate with a lower end of the first open path 221. At this time, a port 225 having a larger diameter is also formed in a side surface for facilitating a following step.

In a second step, as shown in FIG. 22, a blocking member 224 made of a thin circular plate is then inserted in the auxiliary path 223. At this time, the blocking member 224 is placed in such a position that it will be removed while a second open path 226 is formed as mentioned later.

In a succeeding third step, as shown in FIG. 23, the blocking member 224 is welded to the auxiliary path 223, forming a welded portion W.

In a fourth step, as shown in FIG. 24, a second open path 226 is bored, chipping off the blocking member 224 and part of the welded portion W, so that a remainder W1 of the welded portion blocks the auxiliary path 223.

By the aforementioned manufacturing method, the flow path block 201 is produced with a U-shaped path composed of the first open path 221, the communicating path 222, and the second open path 226.

[Patent Document 1] JP-A-2003-097752 (paragraph [0045] and FIG. 2)

### DISCLOSURE OF INVENTION

### Problems to be Solved by the Invention

However, the related art has the following problems.

The flow path block 101 having the V-shaped path as shown in FIGS. 18 and 19 has to ensure a required V-shape inclination angle and a hole diameter of the seal area 121a with respect to a given block thickness. Thus a drill has to be inserted taking account of the V-shape inclination angle, which imposes a limitation on the diameter of the drill, resulting in a restriction on the diameter of the flow path 121. As shown in FIG. 20, specifically, the diameter d of the drill insertable to ensure a predetermined hole diameter D of the seal area 121a is determined from “d≦(D×cos θ)”, as is geometrically obvious, by taking account of tolerance and machining accuracy. The diameter of the flow path 121 determined according to the drill diameter d tends to become smaller than the hole diameter D of the seal area 121a. In addition, if the V-shape inclination angle θ is to be changed, the block thickness has to be increased, which results in an increase in weight of the flow path block 101. It is therefore impossible to change the V-shape inclination angle θ freely to increase the diameter of the flow path 121. Thus, a sufficient effective sectional area could not be provided with respect to the flow rate to be supplied and pressure loss would be likely to increase.

Further, the block needs to have a certain degree of thickness for allowing formation of a flow path at an arbitrary V-shape inclination angle θ.

Further, Patent document 1 has the following problems.

Usually, the shape, diameter, and length of a blade of a tool (e.g. a drill) for forming a flow path are limited to certain degrees. The tool is generally almost circular in section and thus the section of the flow path in the flow path block 201 is also limited to an almost circular shape. Further, the diameter of the tool in section is limited to a certain degree, which leads to a limited sectional area of the flow path. Accordingly, the flow path could not have the sufficient effective sectional area with respect to the flow rate to be supplied. This also causes large pressure loss if a large amount of fluid is allowed to pass in this path, which will restrict the flow rate.

There is also a limitation on workable length. A flow path block provided with a very long flow path could not be produced even when such flow path block is required for convenience of places for installing the fluid control system unit.

Further, only simple paths like V-shaped and U-shaped paths could be formed. Thus, a complex flow path (e.g. a flow block in a supply part for purge gas and process gas) could not be produced even when such flow path block is required for convenience of the places for installing the fluid control system unit.

The present invention has been made in view of the above circumstances and has an object to provide a flow path block capable of providing a flow path of a sectional-area freely designed, a very long flow path, a complex flow path, and achieving weight reduction, and a manufacturing method thereof.

### Means for Solving the Problems

To achieve the above objects, the present invention includes the following configuration or steps.

(1) A flow path block to be used in a fluid control system unit, the block comprises: a block body formed with a through hole and a groove communicating with the through hole; and a lid member which covers the groove.

(2) A flow path block to be used in a fluid control system unit, the block comprises: a block body formed with through holes; and a lid member of a concave shape which provides communication between the through holes.

(3) A flow path block to be used in a fluid control system unit, the block comprises: a block body formed with a through hole and a groove communicating with the through hole; and a lid member which is of a concave shape and covers the groove.

(4) In the flow path block set fort in (1), the groove is of an almost U-shaped section which can be set to an arbitrary size.

(5) In the flow path block set forth in (2) or (3), the concave shape is of an almost U-shaped section which can be set to an arbitrary size.

(6) A method of manufacturing a flow path block to be used in a fluid control system unit, comprises the steps of: forming a through hole in a block body; forming a groove communicating with the through hole; and covering the groove with a lid member.

(7) A method of manufacturing a flow path block to be used in a fluid control system unit, comprises the steps of: forming through holes in a block body; and covering with a lid member of a concave shape which provides communication between the through holes.

(8) A method of manufacturing a flow path block to be used in a fluid control system unit, comprises the steps of: forming a through hole in a block body; forming a groove communicating with the through hole; and covering the groove with a lid member of a concave shape.

(9) In the method of manufacturing a flow path block, set forth in (6), the groove is formed of an almost U-shaped section which can be set to an arbitrary size.

(10) In the method of manufacturing a flow path block, set forth in (7) or (8), the concave shape is formed of an almost U-shaped section which can be set to an arbitrary size.

### Effects of the Invention

The invention having the above features provides the following operations and effects.

The flow path block of the present invention comprises the block body formed with the through hole and the groove communicating with the through hole, and the lid member which covers the groove. The groove can be formed with any depth and width by the cutting tool, and thus an effective sectional area can be ensured to reduce pressure loss. The groove can also be formed in a long shape by the cutting tool, so that a very long flow path can be provided when the groove is covered with the lid member. The groove can be formed freely by the cutting tool to provide a complex flow path. In addition, the thickness of the block body can be reduced to achieve weight reduction.

The flow path block of the present invention comprises a block body formed with through holes; and a lid member of a concave shape which provides communication between the through holes. The concave shape can be formed with any depth and width by machining, and thus an effective sectional area can be ensured to reduce pressure loss. The lid member can also be formed in a long concave shape by machining, so that a very long flow path can be provided when the block body is covered with the lid member. The concave shape can be formed freely by machining to provide a complex flow path. In addition, the block body has only to be formed with the through hole, so that the thickness of the block body can be reduced to achieve weight reduction.

The flow path block of the present invention comprises a block body formed with a through hole and a groove communicating with the through hole; and a lid member which is of a concave shape and covers the groove. The concave shape can have any depth and width by machining, and thus an effective sectional area can be ensured to reduce pressure loss. The groove can also be formed in a long shape by the cutting tool and the lid member can be formed in a long concave shape by machining, so that a very long flow path can be provided when the block body is covered with the lid member. The groove can be formed freely by the cutting tool and also the concave shape can be formed freely by machining to provide a complex flow path. Further, there is no need to make the groove so deep, so that the thickness of the block body can be reduced to achieve weight reduction.

The flow path block of the present invention may be arranged such that the groove is of an almost U-shaped section which can be set to an arbitrary size. Thus, the flow path can have an arbitrary effective sectional area to reduce the pressure loss.

The flow path block of the present invention may be arranged such that the concave shape is of an almost U-shaped section which can be set to an arbitrary size. Accordingly, the flow path can have a larger effective sectional area to reduce the pressure loss.

The method of manufacturing a flow path block of the present invention comprises the steps of: forming a through hole in a block body; forming a groove communicating with the through hole; and covering the groove with a lid member. The groove can be formed with any depth and width by the cutting tool, and thus an effective sectional area can be ensured to reduce pressure loss. The groove can also be formed in a long shape by the cutting tool, so that a very long flow path can be provided when the groove is covered with the lid member. The groove may be formed freely by the cutting tool to provide a complex flow path. Further, the thickness of the block body can be reduced to achieve weight reduction.

The method of manufacturing a flow path block of the present invention comprises the steps of: forming through holes in a block body; and covering with a lid member of a concave shape which provides communication between the through holes. The concave shape can be formed with any depth and width by machining, and thus an effective sectional area can be ensured to reduce pressure loss. The lid member can also be formed in a long concave shape by machining, so that a very long flow path can be provided when the block body is covered with the lid member. The concave shape can be formed freely by machining to provide a complex flow path. In addition, the block body has only to be formed with the through hole, so that the thickness of the block body can be reduced to achieve weight reduction.

The method of manufacturing a flow path block of the present invention comprises the steps of: forming a through hole in a block body; forming a groove communicating with the through hole; and covering the groove with a lid member of a concave shape. The concave shape can be formed with any depth and width by machining, and thus an effective sectional area can be ensured to reduce pressure loss. The groove can also be formed in a long shape by the cutting tool and the lid member can be formed in a long concave shape by machining, so that a very long flow path can be provided when the block body is covered with the lid member. The groove can be formed freely by the cutting tool and also the concave shape can be formed freely by machining to provide a complex flow path. Further, there is no need to make the groove so deep, so that the thickness of the block body can be reduced to achieve weight reduction.

According to the manufacturing process of the flow path block of the present invention, the groove is formed of an almost U-shaped section which can be set to an arbitrary size. Thus, the flow path can have a larger effective sectional area to reduce the pressure loss.

According to the manufacturing process of the flow path block of the present invention, the concave shape can be formed of an almost U-shaped section which can be set to an arbitrary size. Thus, the flow path can have a larger effective sectional area to reduce the pressure loss.

### BRIEF DESCRIPTION OF DRAWINGS

FIG. 1 is an external view (a partially sectional view) of a flow path block of a first embodiment;

FIG. 2 is a top view of a block body of the first embodiment;

FIG. 3 is a sectional view (a section taken along line A-A in FIG. 1) of the block body of the first embodiment;

FIG. 4 is a bottom view of the block body of the first embodiment;

FIG. 5 is a sectional view (a section taken along line B-B in FIG. 4) of the block body of the first embodiment;

FIG. 6 is an external top view of a lid member of the first embodiment;

FIG. 7 is an external side view of the lid member of the first embodiment;

FIG. 8 is a view showing one example of a manufacturing method of the flow path block of the first embodiment;

FIG. 9 is a view showing one example of a manufacturing method of the flow path block of the first embodiment;

FIG. 10 is a view showing one example of a manufacturing method of the flow path block of the first embodiment;

FIG. 11 is a view showing one example of a manufacturing method of the flow path block of the first embodiment;

FIG. 12 is a view showing a flow path block formed with a very long flow path in the first embodiment;

FIG. 13 is a view showing a flow path block formed with a complex flow path in the first embodiment;

FIG. 14 is a view showing a flow path block formed with a multilayered flow path in the first embodiment;

FIG. 15 is a sectional view of a groove in the first embodiment;

FIG. 16 is a sectional view of a groove in the first embodiment;

FIG. 17 is a schematic view of a configuration of a flow path block of a second embodiment;

FIG. 18 is a view showing a flow path block with a V-shaped flow path in a related art;

FIG. 19 is a view showing the flow path block with the V-shaped flow path in a related art;

FIG. 20 is a view showing a seal part and its surrounding parts of the flow path block with the V-shaped flow path in a related art;

FIG. 21 is a schematic view of a flow path block manufacturing method in Patent document 1;

FIG. 22 is a schematic view of the flow path block manufacturing method in Patent document 1;

FIG. 23 is a schematic view of the flow path block manufacturing method in Patent document 1; and

FIG. 24 is a schematic view of the flow path block manufacturing method in Patent document 1.

### EXPLANATION OF REFERENCE CODES

1 Flow path block

11 Block body

12 Lid member

13 Lid member

21 Through hole

22 Groove

22a Lid receiving portion

### BEST MODE FOR CARRYING OUT THE INVENTION

An embodiment of the present invention will be described below.

### First Embodiment

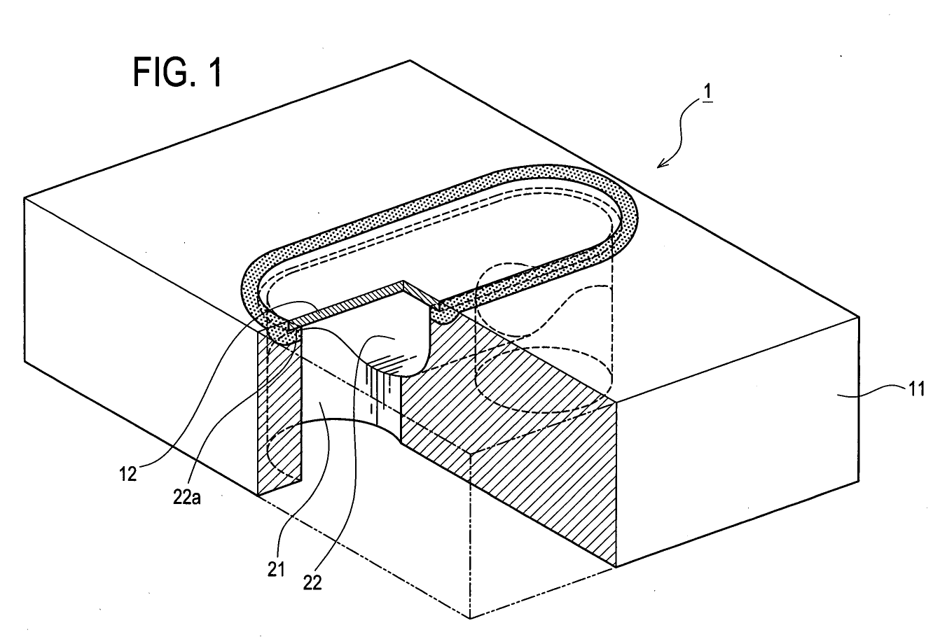

A flow path block 1 of a first embodiment will be explained first. FIG. 1 is an external view (a partially sectional view) of the flow path block 1.

The flow path block 1 is composed of a block body 11 and a lid member 12 as shown in FIG. 1.

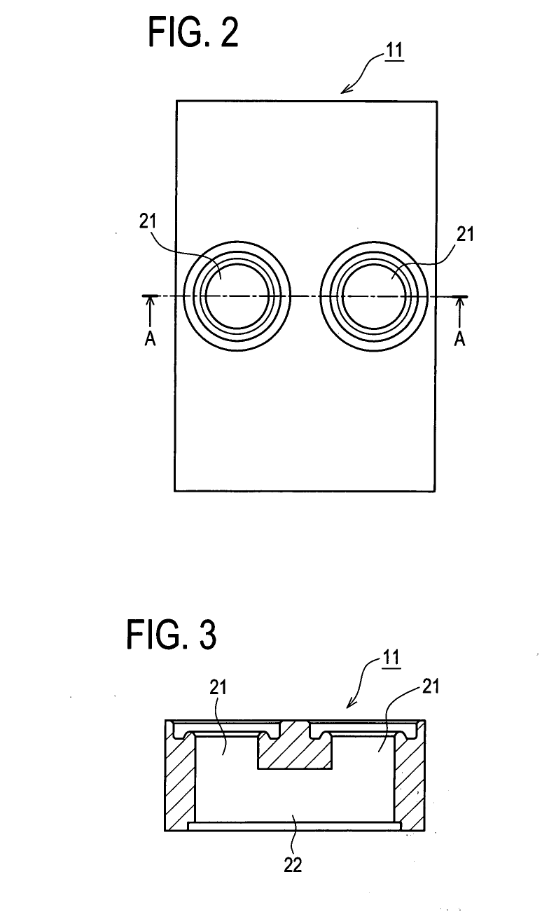

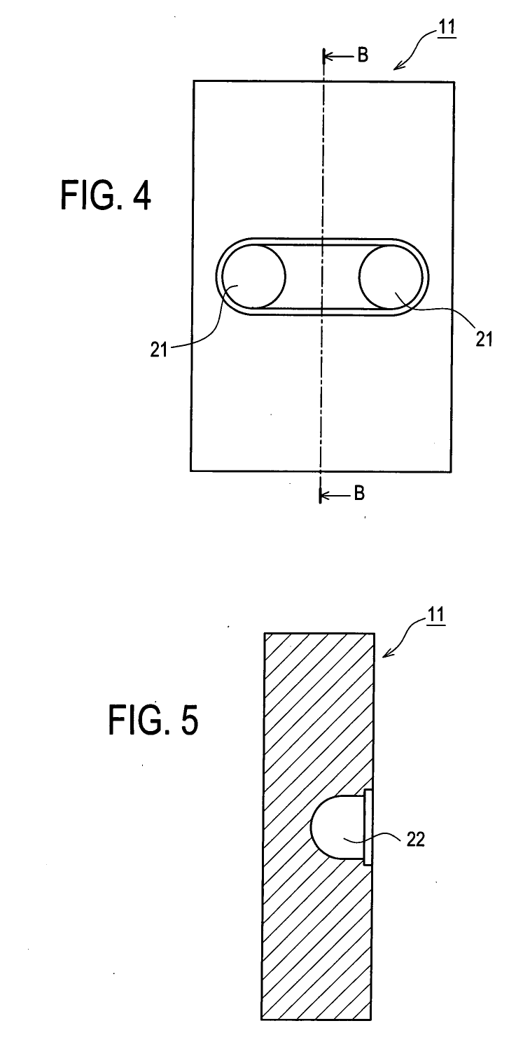

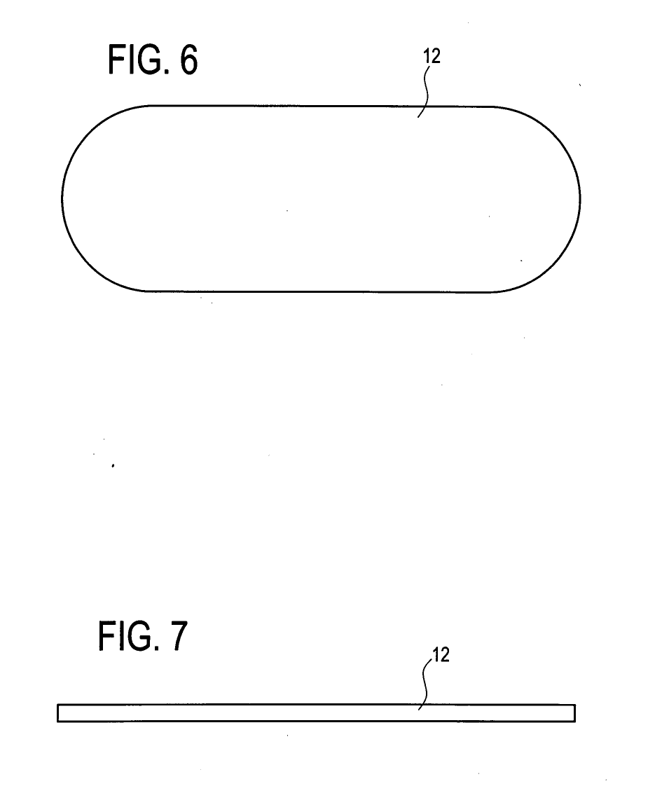

FIGS. 2 to 5 show a configuration of the block body 11; FIG. 2 is a top view, FIG. 3 is a sectional view taken along line A-A, FIG. 4 is a bottom view, and FIG. 5 is a sectional view taken along line B-B. As shown in FIGS. 2 to 5, the block body 11 is formed with through holes 21 and a groove 22. In the flow path block 1, the groove 22 is covered to be hermetically closed with the lid member 12 shown in FIGS. 6 and 7. The lid member 12 is made of sheet metal or the like, which is attached to the block body 11 by welding (e.g., TIG welding and laser welding).

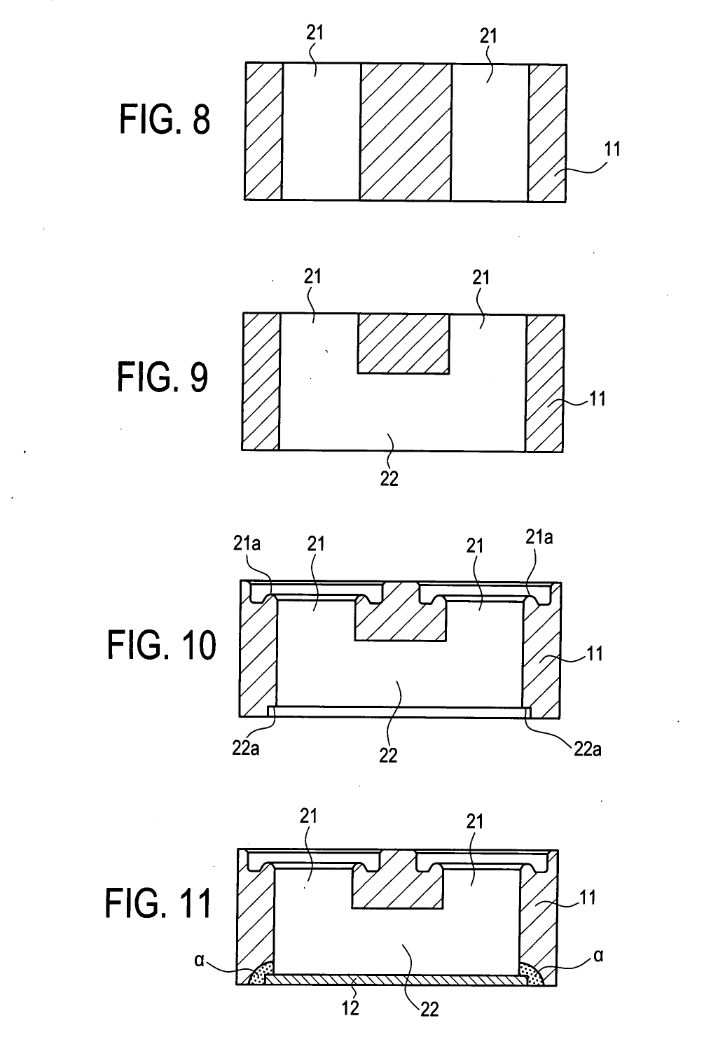

Here, one example of a method of manufacturing the flow path block 1 will be described. FIGS. 8 to 11 are mainly sectional views of the block body 11.

In a first step, as shown in FIG. 8, two through holes 21 are bored into the block body 11 made of material such as SUS 316 by a drill or the like.

In a second step, as shown in FIG. 9, a groove 22 is formed to provide communication between the two through holes 21 by a cutting tool such as an end mill.

In a s third step, successively, as shown in FIG. 10, a lid receiving portion 22a is formed on the bottom surface side of the block body 11 for receipt of the lid member 12 mentioned later. On the other hand, seal areas 21a which will be mated with a unit to be mounted thereon are formed on the upper surface side of the block body 11.

In a fourth step, as shown in FIG. 11, the lid member 22 produced in the same shape as that of an opening of the groove 22 is set in the lid receiving portion 22a to cover the groove 22, and then the lid member 22 is welded to the block body 11 by laser welding. For fully hermetically closing the groove 22, a bead is formed over an area (a portion a indicated in FIG. 11) around the welded portion during the welding.

By the above manufacturing method, it is possible to provide the through hole 21 having the same diameter as the hole diameter of the seal area 21a. The groove 22 can also be formed with any depth and width by the cutting tool such as the end mill. This will cause no problem that a limitation is imposed on the diameter of a flow path to ensure a predetermined hole diameter of each seal area 21a as in the flow path block 101 in the related art. Thus, in the flow path block 1 of the present invention, each through hole 21 is formed with the same diameter as the hole diameter of each seal area 21a and the groove 22 is formed with the depth larger than the hole diameter of each seal area 21a, so that the flow path may be formed with the diameter equal to or larger than the hole diameter of the seal area 21a. The flow path can therefore have an increased effective sectional area, making it possible to reduce pressure loss when a fluid passes through the flow path.

In the flow path block 101 and flow path block 201 in the related art, the flow paths are formed by the cutting tool such as a drill, so that the section shape and the diameter of the flow path tend to depend on the shape of the cutting tool and the tool diameter.

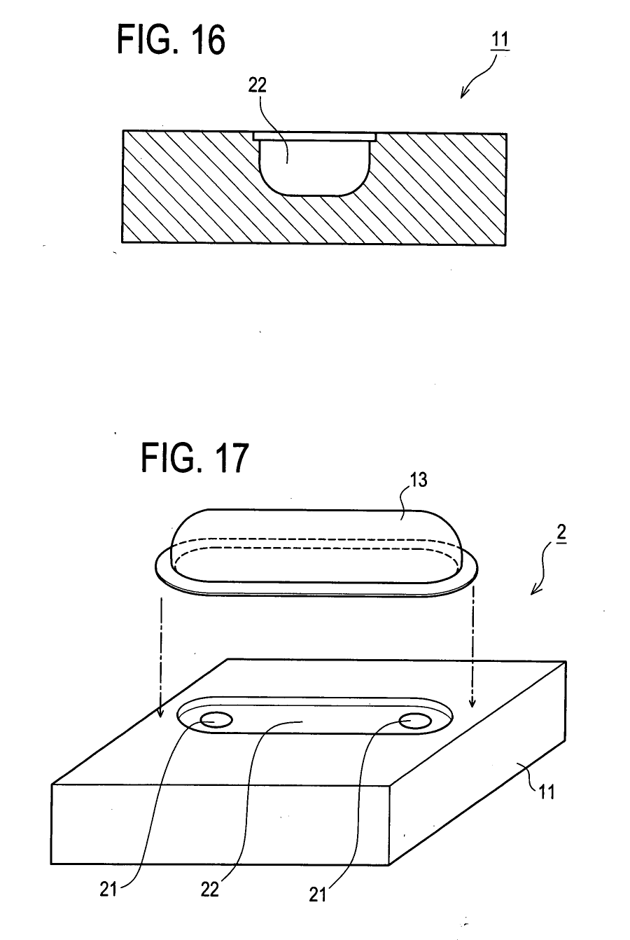

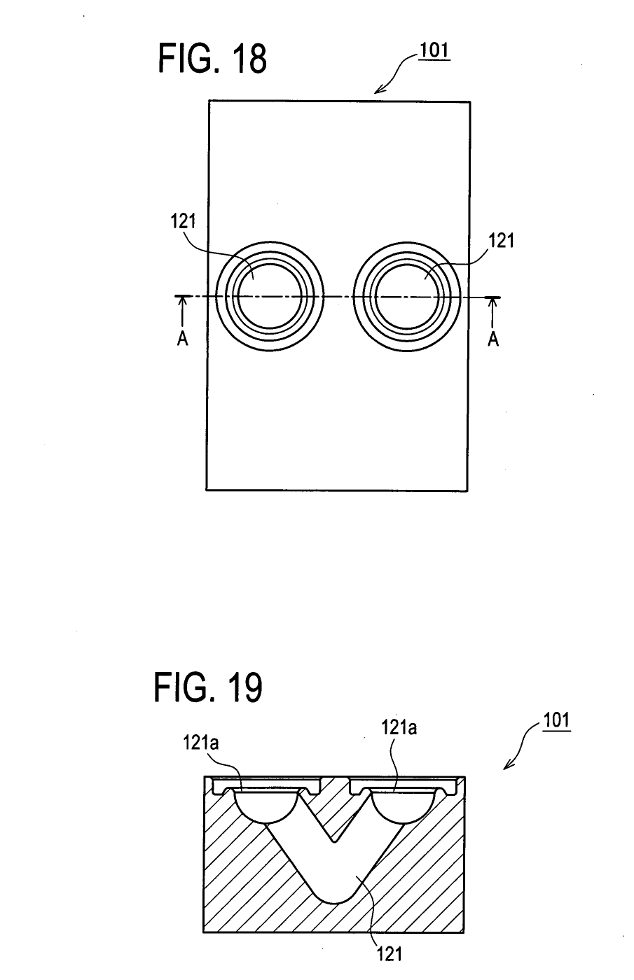

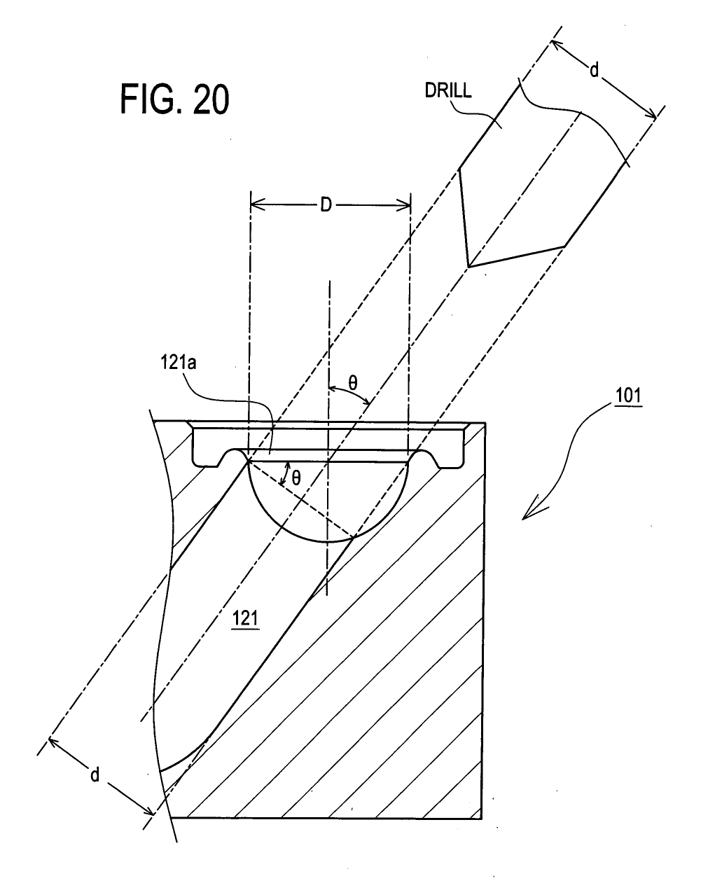

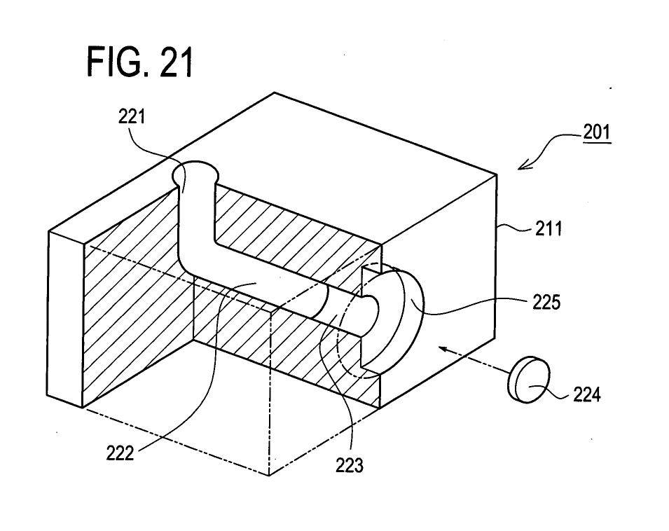

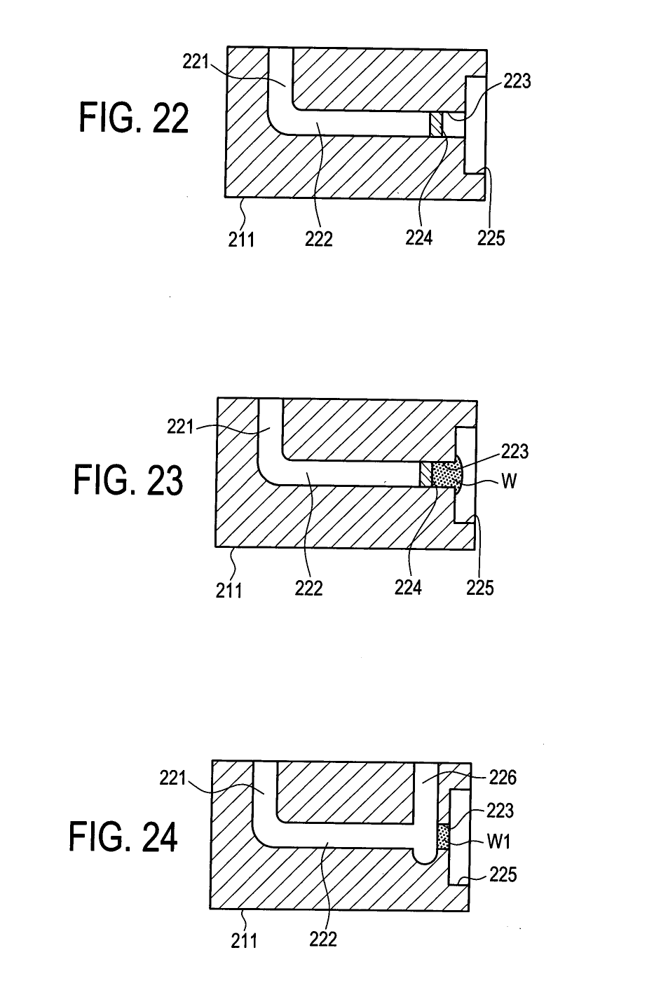

According to the present invention, on the other hand, the groove 22 can be formed in desired section shape and section size (width, depth, etc.) by use of the end mill or the like. It is therefore possible to design as intended the groove 22 to have an almost U-shaped section with a depth larger than a width as shown in FIG. 15 and an almost U-shaped section with a width larger than a depth as shown in FIG. 16, so that the flow path can have a larger effective sectional area. Consequently, the flow path block 1 can be manufactured with less fluid pressure loss.

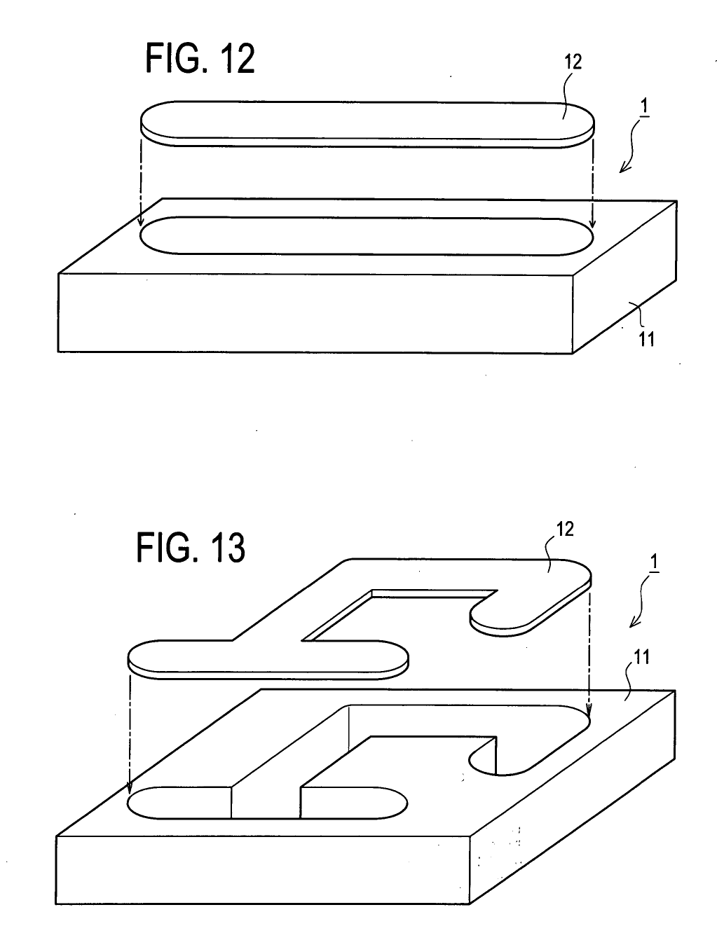

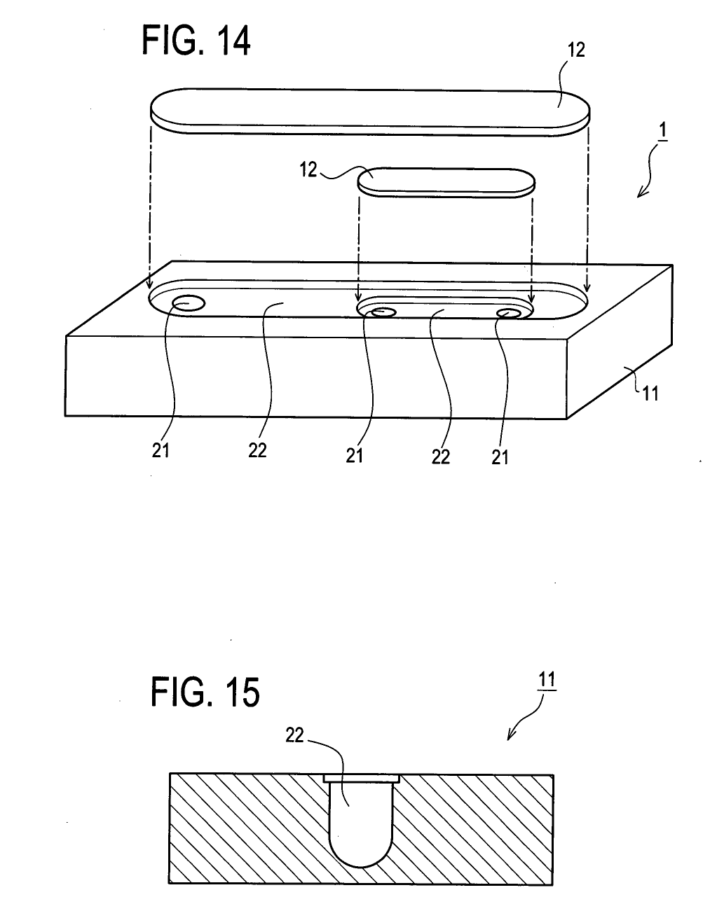

Further, as mentioned in the related art, the common machining work for boring a hole would impose a limitation on the length of a flow path according to the length of the drill. According to the present invention, the groove 22 can be formed simply by the cutting tool such as an end mill without such limitation. This makes it possible to form a very long flow path shown in FIG. 12, a complex flow path shown in FIG. 13, or a flow path block having a multilayered flow path configuration shown in FIG. 14.

Further, there is no need for taking account of the V-shape inclination angle θ in the flow path block 101 in the related art. The block thickness can be determined freely according to a place where the flow path block 1 is to be installed. Minimizing the block thickness may reduce the weight of the flow path block 1.

The aforementioned first embodiment can bring about the following effects.

The flow path block 1 of the present invention includes the block body 11 formed with the through holes 21 and the groove 22 communicating with the through hole 21, and the lid member 12 which covers the groove 22. The groove 22 can be formed with any depth and width by the cutting tool to reduce the pressure loss. The groove 22 can be formed in a long shape by the cutting tool, so that a very long flow path can be provided when the groove 22 is covered with the lid member 12. The groove 22 can be formed freely by the cutting tool to provide a complex flow path. In addition, the block body 11 can be reduced in thickness to achieve weight reduction.

The flow path block 1 of the present invention is arranged such that the groove 22 is of an almost U-shaped section which can be set to an arbitrary size. The flow path can therefore have a larger effective sectional area, thus reducing the pressure loss.

The manufacturing method of the flow path block 1 of the present invention comprises the steps of forming the through holes 21 in the block body 11, forming the groove 22 communicating with the through holes 21, and covering the groove 22 with the lid member 12. The groove 22 can be formed with any depth and width by the cutting tool, reducing the pressure loss. The groove 22 can also be formed to be long by the cutting tool, so that a very long flow path can be provided when the groove 22 is covered with the lid member 12. The groove 22 can be formed freely by the cutting tool to provide a complex flow path. In addition, the thickness of the block body 11 can be reduced to achieve weight reduction.

According to the manufacturing method of the flow path block 1 of the present invention, the groove 22 can be formed of an almost U-shaped section, which may be designed to have an arbitrary size, so that the flow path may have a larger effective sectional area, thus reducing the pressure loss.

### Second Embodiment

Next, a flow path block 2 of a second embodiment will be explained. FIG. 17 is an external view of the configuration of the flow path block 2.

A difference from the first embodiment is in that a lid member 13 is previously formed with a flow path (concave shape) by press working or the like. This makes it possible to provide a flow path having a necessary diameter even when the block body 11 is formed with no groove 22 or with a groove 22 of a small depth. The thickness of the block body 11 can therefore be reduced, thus achieving further weight reduction of the flow path block.

Other effects resulting from the machining on the lid member 13 are the same as in the first embodiment; that is, the pressure loss of fluid when passes can be reduced and a very long flow path, a complex flow path, and a flow path block having a multilayered flow path configuration can be formed.

According to the second embodiment mentioned above, the following effects can be obtained.

The flow path block 2 of the present invention comprises the block body 11 formed with the through holes 21 and the lid member 13 of a concave shape which provides communication between the through holes 21. The concave shape can be formed with any depth and width by machining, and thus an effective sectional area can be ensured to reduce pressure loss. The lid member 13 can be formed in a long concave shape by machining, so that a very long flow path can be provided when the block body 11 is covered with the lid member 13. The concave shape can be formed freely by machining to provide a complex flow path. Further, the block body 11 has only to be formed with the through holes 21, so that the thickness of the block body 11 can be reduced to achieve weight reduction.

The flow path block 2 of the present invention comprises the block body 11 formed with the through holes 21 and the groove 22 communicating with the through holes 21 and the lid member 13 having a concave shape and covering the groove. The concave shape can be formed with any depth and width by machining to ensure an effective sectional area and thus reduce pressure loss. The groove 22 can also be formed in a long shape by machining using the cutting tool and the lid member 13 made in a long concave shape by machining, so that a very long flow path can be provided when the block body 11 is covered with the lid member 13. The groove 22 can be formed freely by the cutting tool and also the concave shape can be formed freely by machining, which makes it possible to provide a complex flow path. Further, the block body 11 has only to be formed with the through holes 21, so that the thickness of the block body 11 can be reduced to achieve weight reduction.

The flow path block 2 of the present invention can have the concave shape of an almost U-shaped section which can be set to an arbitrary size. The flow path can therefore have a larger effective sectional area, reducing the pressure loss.

The manufacturing method of the flow path block 2 of the present invention comprises the steps of forming the through holes 21 in the block body 11, and covering with the lid member 13 of the concave shape which provides communication between the through holes 21. The concave shape can be formed with any depth and width by machining to ensure an effective sectional area and thus reduce pressure loss. The lid member 13 can also be formed in a long concave shape by machining, so that a very long flow path can be provided when the block body 11 is covered with the lid member 13. The concave shape can be formed freely by machining to provide a complex flow path. Further, the block body 11 has only to be formed with the through holes 21, so that the thickness of the block body 11 can be reduced to achieve weight reduction.

The manufacturing method of the flow path block 2 of the present invention comprises the steps of forming the through holes 21 in the block body 11, forming the groove 22 communicating with the through holes 21, and covering the groove 22 with the lid member 13 of the concave shape. The concave shape can be formed with any depth and width by machining, and thus an effective sectional area can be ensured to reduce pressure loss. The groove 22 can also be formed in a long shape by the cutting tool and the lid member 13 can be formed in a long concave shape by machining, so that a very long flow path can be provided when the block body 11 is covered with the lid member 13. The groove 22 can be made freely by the cutting tool and the concave shape can also be formed freely by machining, which makes it possible to provide a complex flow path. Further, the block body 11 has only to be formed with the through holes 21, so that the thickness of the block body 11 can be reduced to achieve weight reduction.

The flow path block 2 of the present invention can have the concave shape of an almost U-shaped section which can be set to an arbitrary size. The flow path can therefore have a larger effective sectional area, reducing the pressure loss.

The present invention is not limited to the above embodiments and may be embodied in other specific forms without departing from the essential characteristics thereof.

1. A flow path block to be used in a fluid control system unit, the block comprising:
a block body formed with a through hole and a groove communicating with the through hole; and
a lid member which covers the groove.

2. A flow path block to be used in a fluid control system unit, the block comprising:
a block body formed with through holes; and
a lid member of a concave shape which provides communication between the through holes.

3. A flow path block to be used in a fluid control system unit, the block comprising:
a block body formed with a through hole and a groove communicating with the through hole; and
a lid member which is of a concave shape and covers the groove.

4. The flow path block according to claim 1, wherein
the groove is of an almost U-shaped section which can be set to an arbitrary size.

5. The flow path block according to claim 2, wherein
the concave shape is of an almost U-shaped section which can be set to an arbitrary size.

6. A method of manufacturing a flow path block to be used in a fluid control system unit, the method comprising the steps of:
forming a through hole in a block body;
forming a groove communicating with the through hole; and
covering the groove with a lid member.

7. A method of manufacturing a flow path block to be used in a fluid control system unit, the method comprising the steps of:
forming through holes in a block body; and
covering the block body with a lid member of a concave shape which provides communication between the through holes.

8. A method of manufacturing a flow path block to be used in a fluid control system unit, the method comprising the steps of:
forming a through hole in a block body;
forming a groove communicating with the through hole; and
covering the groove with a lid member of a concave shape.

9. The method of manufacturing a flow path block according to claim 6, wherein
the groove is formed of an almost U-shaped section which can be set to an arbitrary size.

10. The method of manufacturing a flow path block according to claim 7, wherein
the concave shape is formed of an almost U-shaped section which can be set to an arbitrary size.

11. The flow path block according to claim 3, wherein
the concave shape is of an almost U-shaped section which can be set to an arbitrary size.

12. The method of manufacturing a flow path block according to claim 8, wherein
the concave shape is formed of an almost U-shaped section which can be set to an arbitrary size.
